(19) United States
(12) Patent Application Publication
(10) Pub. No.: US 2006/0241997 A1
(43) Pub. Date: Oct. 26, 2006

(54) System and method for integrating workflow processes with a project management system

(75) Inventors: Ameya S. Bhatawdekar, Sammamish, WA (US); Imran Aziz, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/111,590

(22) Filed: Apr. 20, 2005

(51) Int. Cl. G06F 9/46

(52) U.S. Cl. 705/9

(57) ABSTRACT

A project management system is integrated with a workflow engine to provide automatic coordination of project tasks and workflow processes. The workflow engine provides support for defining logical expressions that determine a path of execution for the defined workflow tasks. In addition to composition capabilities, the workflow engine may execute and track the defined processes. The project management system provides a platform for defining the project plan that includes tasks and resources. Tasks are annotated defining their behavior and implementation and exported to the workflow system. The workflow system substitutes project tasks with the appropriate workflow activities and provides feedback upon execution of the activities.

### BACKGROUND OF THE INVENTION

Automated workflow technologies are a significant component for enhancing productivity in the workplace. By bringing the science of computer automation to business processes, workflow technologies promise to apply the power of software to the way companies do business.

Automated workflow technologies can represent a business process in software as a workflow. Workflow designers typically break the business process into discrete pieces that are to be performed and monitored until some completion criteria are achieved.

Project management and workflow systems have common aspects. Both comprise of a set of tasks assigned to individuals or systems that need to be carried out in a certain sequence to achieve a desired objective. Project management and workflow systems also have unique features and differences. While project management systems deal with projects, workflow systems manage and automate processes. Project management systems are designed to optimize a project plan for resource utilization, cost, and duration, as well as provide tracking and reporting capabilities. Projects are typically exceptions to ongoing processes with a start and an end date, whereas a workflow system automates business processes that are predictable and repeatable.

Furthermore, project management systems provide support for time and sequence based conditional constraints, such as Finish to Start (FS) and Finish No Later Than (FNLT) constraints. Primarily, constraints may be categorized into flexible and inflexible constraints.

A constraint is flexible, if it does not tie a task to a single date. Examples of flexible constraints are As Soon As Possible, As Late As Possible, Finish No Earlier Than, Finish No Later Than, Start No Earlier Than, and Start No Later Than. A constraint is inflexible, if it ties a task to a date. Examples of inflexible constraints are Must Finish On and Must Start On.

Typically, project management systems only deal with time and sequence based constraints and lack the constructs for defining more complex constraints like those that can be defined in workflow systems. Workflow systems allow definition and evaluation of much more complex conditional conditions constraints such as “If the date is later than the fiscal year end and the submitted invoice is greater than $5000.00, seek manager approval”.

In many instances sub-processes within a project include one or more workflow tasks, or the project results in one or more workflow tasks. Because of the above-described differences in the nature of project and workflow processes, automation and development of those has been approached separately in the past.

### SUMMARY OF THE INVENTION

Embodiments of the present invention relate to a system and method for integrating a project management system with workflow processes. A project management system coordinates project tasks with workflow activities managed by a workflow engine. The workflow engine provides support for defining logical expressions that determine a path of execution for the defined workflow tasks. In addition to composition capabilities, the workflow engine may execute and track the defined processes. The project management system provides a platform for defining the project plan that includes tasks and resources. Tasks are annotated defining their behavior and implementation and exported to the workflow system. The workflow system substitutes project tasks with the appropriate workflow activities and provides feedback upon execution of the activities.

In accordance with one aspect of the present invention, a computer-implemented method for workflow instrumentation within a project is provided. The method includes providing a platform for constructing a project plan and configuring the project plan to allow association with a workflow component. The project plan is employed to define a workflow type. The computer-implemented method further includes providing an automated coordination between the workflow component and at least one portion of the project plan.

According to another aspect of the present invention, the computer-implemented method further includes defining one or more project tasks associated with the project plan and scheduling the one or more project tasks. Following the method resources and staff are assigned to the one or more project tasks that are associated with at least one workflow component.

According to a further aspect of the present invention, at least one project task is annotated to provide the definition of the workflow component type, and the annotated project task transferred to a workflow system such that associated workflow components are organized within the workflow system.

### BRIEF DESCRIPTION OF THE DRAWINGS

FIG. 1 illustrates a computing device that may be used according to an example embodiment.

FIG. 2 is a block diagram of a network environment, in which a project management application according to the present invention may be implemented.

FIG. 3 is a block diagram illustrating interactions between a project management system and a workflow system.

FIG. 4 is a diagram illustrating an example workflow system and its operation over a network according to a further embodiment.

FIG. 5 is a diagram illustrating example functional blocks of the workflow system of FIG. 4 and its interactions.

FIG. 6 is a logic flow diagram illustrating a project management process in coordination with workflow management.

### DETAILED DESCRIPTION

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

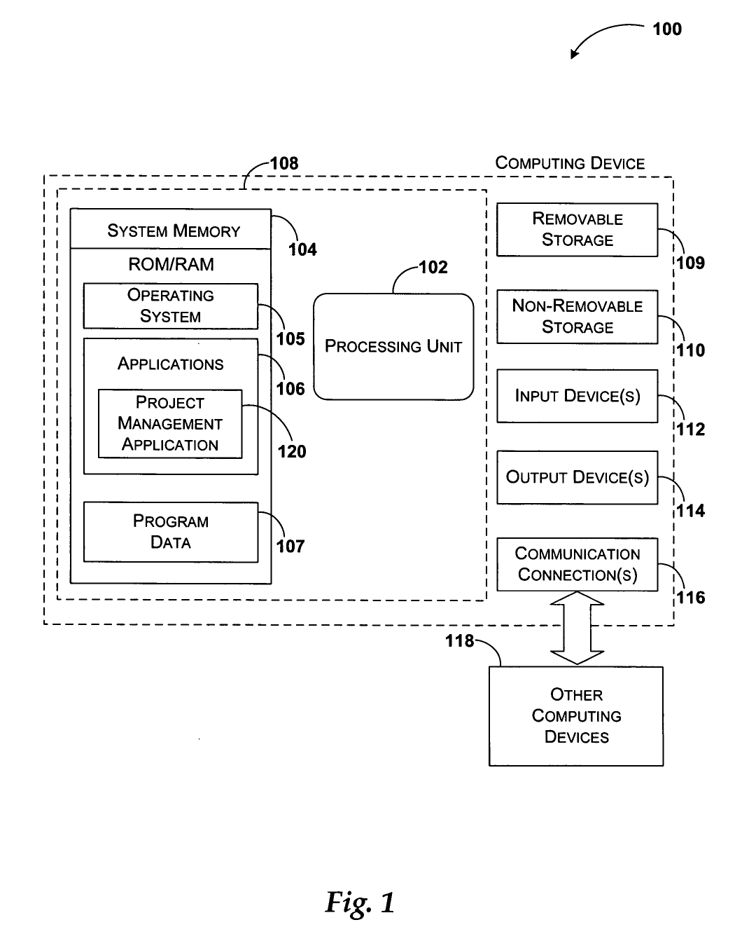

Referring to FIG. 1, an example system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes an operating system 105, one or more applications 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 also contains communications connection(s) 116 that allow the device to communicate with other computing devices 118, such as over a network or a wireless mesh network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one embodiment, applications 106 further include project management application 120, which is arranged to manage various tasks involved in a project. Project management application 120 may include creation, organization, tracking, and presentation of a number of sub-processes in a project. Project management application 120 may further include creation, organization, tracking, and coordination of a number of workflow tasks associated with the project. Project management application 120 may receive information associated with the project and the workflow tasks from a user, one or more databases, or a combination of the two. User input may be provided through input device 112 or communication connection 116. The one or more databases may be stored in one of the storage devices of computing device 100, or in a remote storage device (not shown).

Project management application 120 may provide an output, which may be a graphics file, an email message, or another file containing information associated with the project or the workflow tasks to output device 114, one of the storage devices, or to an external device, such as a networked printer, through communication connection 116.

Illustrative Embodiments For Providing Integrated Project Management and Workflow Processes

Embodiments of the present invention are related to integrating project management and workflow systems. A project plan may include arbitrary levels of project tasks that are hierarchically related. These tasks and their status as the project plan is executed may be presented to a user graphically in various views such as Gantt view, Network Diagram view, Calendar view, and may be scheduled by various scheduling methods such as Program Evaluation and Review Technique (PERT) and Critical Path Method (CPM) for optimal resource, time and scope management.

Planning and scheduling a process for an optimal execution plan may take place in a project management system and subsequently automated in a workflow system. Workflow processes typically result from a project plan. Project plans enable designers and other participants to staff, assign resources, and track progress of a project from conception to production. Project plan components and workflow processes may correspond to each other, overlap, or depend from each other.

Progress of existing process instances may be reported back to the project management system for tracking and reporting. The workflow system may report an analysis of workflow action results, a workflow metric, an alert, or a request to a user. The report may be transmitted to an application that executes the project plan, a web browser, or a message exchange application.

Automation of project management and workflow processes provides for streamlining of design, production, service, and other aspects of a business along with the ability to track various processes accurately. Feedback from tracking various processes may result in enhancement of quality, cost-effectiveness, and time-to-market.

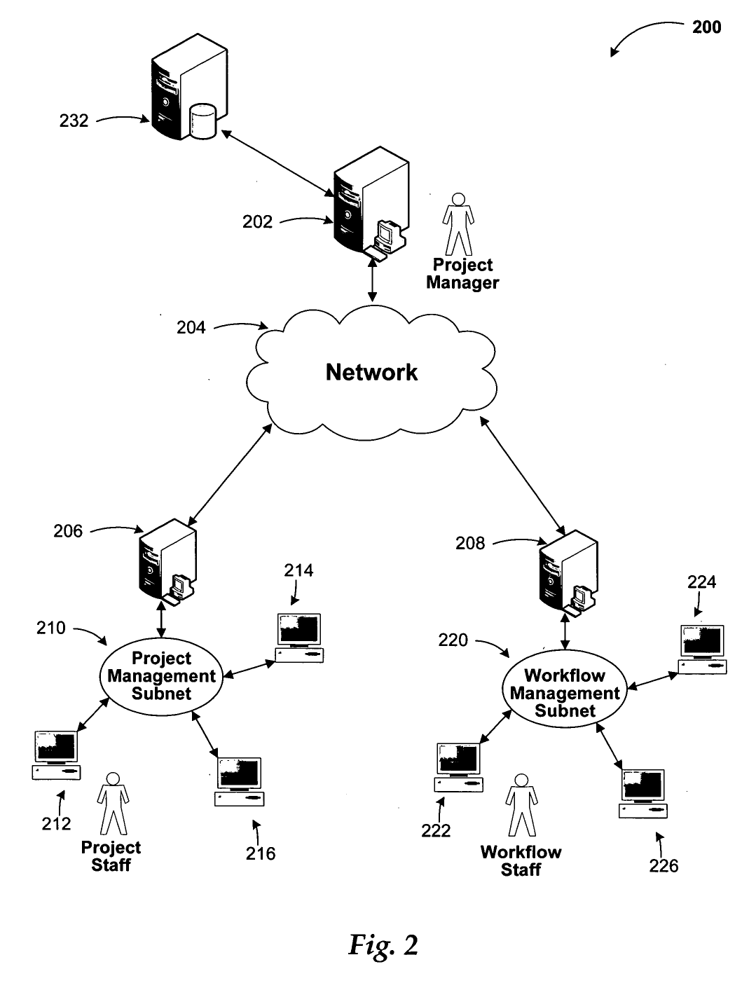

FIG. 2 is a block diagram of network environment 200, in which a project management application according to the present invention may be implemented. Network environment 200 includes management servers 202, 206 and 208, which communicate with each other over network 204. Management server 202 may further communicate with database server 232 directly or over network 204.

In one embodiment, management server 202 may be arranged to execute a project management application such as project management application 120 of FIG. 1. A project manager may control the operation of the project management application on management server 202. Data associated with the execution of project management application and output information generated by the application may be stored in database server 232. Output information may also be stored in individual machines connected to the network or provided to users through other methods such as printouts, emails, and the like.

In another embodiment, project management application may include integrated sub processes for project related tasks and workflow related tasks. These tasks may be executed and managed on separate sub-networks such as project management subnet 210 and workflow management subnet 220. Each subnet may include a management server such as management servers 206 and 208, respectively. Each subnet may also include client devices or applications as represented in the figure by client devices 212, 214, 216 for project management subnet 210 and client devices 222, 224, 226 for project management subnet 220. Project staff may access project related aspects of the project management application through one of the clients on their subnet, and workflow staff may access workflow related aspects of the project management application through one of the clients on their subnet. The project staff may manage workflow aspects of the project through the project application as well.

In a further embodiment, project and workflow related tasks may be executed and accessed by staff on the same network or computing device. As described previously, project management application is arranged to integrate project related tasks and workflow processes such that workflow actions resulting from project tasks are managed, tracked, and results reported to the project management.

Project tasks and workflow processes may be categorized and assigned to different types that determine one or more actions to be performed. Tracking and reporting of tasks and processes may also depend on their category. For example, project tasks may be categorized under resources, staffing, and the like, while workflow categories may include prototype manufacture, inspection, and the like. Categories provided here are not intended to constitute a limitation on the present disclosure. Embodiments may be implemented with fewer or additional categories, as well as with other grouping of categories without departing from the scope and the spirit of the invention.

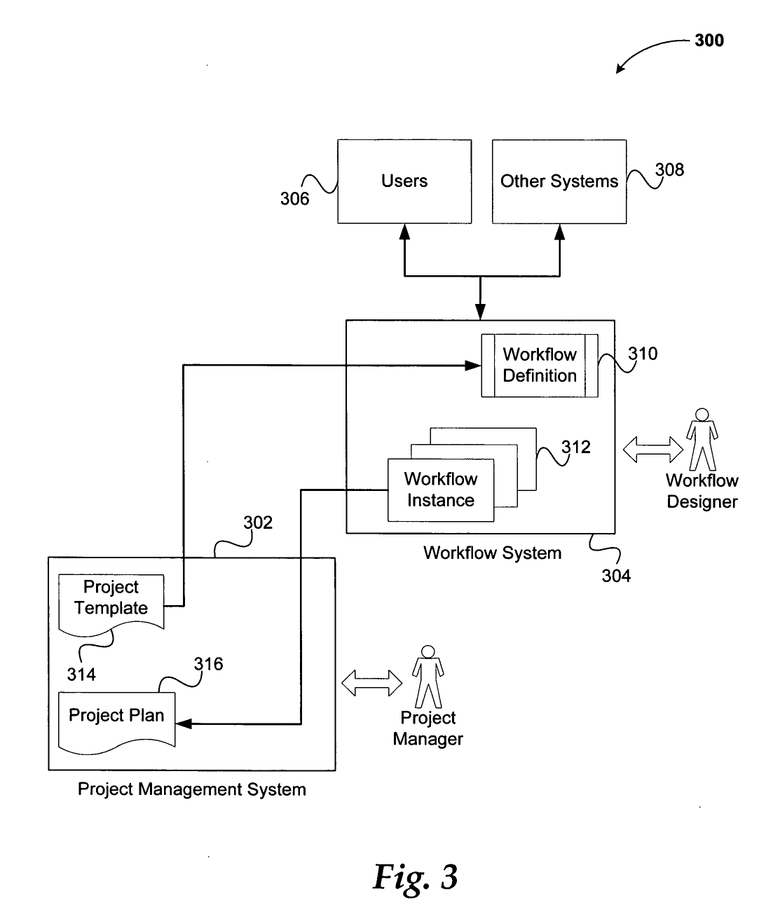

FIG. 3 shows block diagram 300 illustrating interactions between a project management system and a workflow system. Block diagram 300 includes project management system 302, workflow system 304, users 306 and other systems 308. A project manager administers project management system 302, which includes project template 314 and project plan 316. A workflow designer administers workflow system 304, which includes workflow definition 310 and workflow instances 312.

Project management system 302 provides a platform for defining project template 314. Project template 314 may include tasks and resources. Each task may have one or more resources assigned to it. Tasks may have conditional association with other tasks and may have time and/or sequence based constraints defined. Some tasks may be recurring. Project managers use the project management system to optimize project execution and resource utilization. For projects that are repetitive with the same tasks being repeated as part of each project instance, project managers may choose to automate the project using workflow system 304.

For projects that are to be exported to workflow system 304, each task may be annotated (e.g. with metadata) defining its behavior and implementation in the workflow system. For example, a “Create RFP document” may be annotated with metadata defining that this task is a “document creation” task. That way, when the task is exported as a workflow task, workflow system 304 can use the appropriate workflow activity to represent this task.

An entire project plan or portions of it may be exported as a workflow definition (310) that can be consumed by workflow system 304. It should be noted, that the project management system (302) may generate a workflow definition that is compatible with the execution scheme of workflow system 304 by substituting project tasks with appropriate workflow activities. That way a workflow designer does not have to manually import the project-produced workflow definition 310 and annotate it. On the other hand, the workflow designer may be enabled to further customize the workflow beyond what the project system is capable of producing. This may be accomplished during or after the transformation of the project data into workflow definition data.

The workflow tasks may include the implementation of the activity (e.g. code that creates a new RFP document at a specified location, or to send and/or receive data to/from a user). The workflow designer may define additional business rules using code or a business rules engine and add additional business logic to the workflow. Upon completing the transfer (and translation) of project tasks to workflow tasks, workflow system 304 may be deployed for execution of the tasks.

Workflow instances 312 are created for each instance of the business process. Workflow system 304 manages the execution and behavior of workflow instances 312 and addresses workflow related aspects such as correlating message, invoking automation components in other systems, messaging, dehydrating and hydrating workflow instances, managing compensating actions, managing system resources such as threads, memory, and the like.

As workflow tasks are executed, progress may be tracked and reported to project management system 302 for running and completed instances of workflows. This workflow instance data may be transformed into project data and made available to the project system. The transformation may be performed when project management system 302 requests the data or on a scheduled basis where workflow data is transformed and saved as project plans.

Workflow system 304 may invoke the implementation associated with workflow actions from other systems 308 and/or interact with users 306 who may participate in the workflow.

While specific examples of workflow tasks and activities are shown here, the invention is not so limited. Other components of project and workflow systems may be implemented without departing from the scope and spirit of the invention.

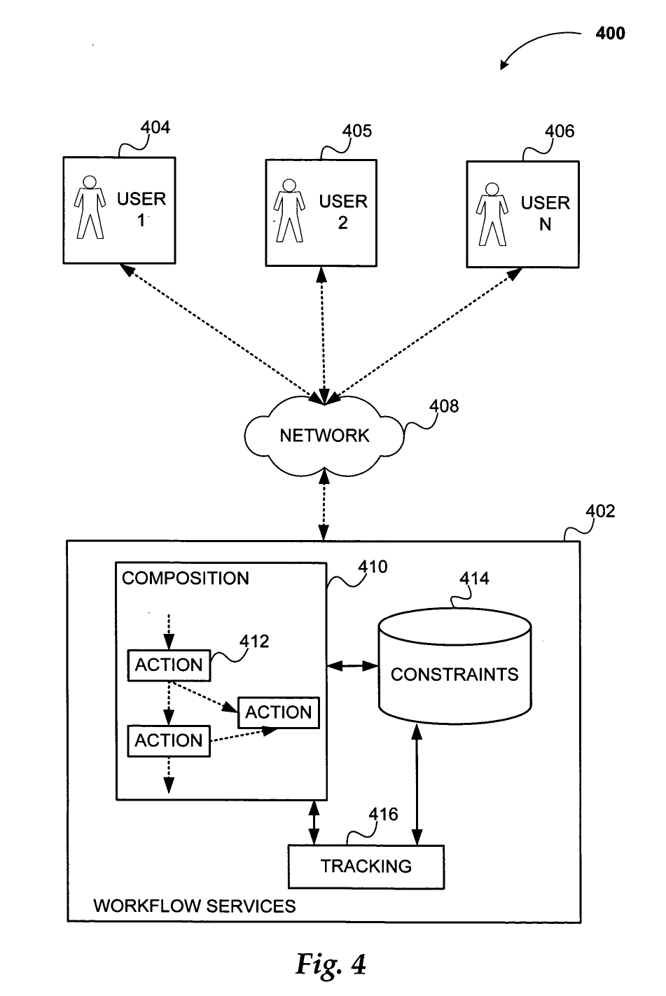

FIG. 4 is a diagram illustrating example workflow system 400 and its operation over a network according to a further embodiment. Workflow system 400 includes workflow services 402, users 404-406, and network 408. Users 404-406 represent workflow designers and other staff involved in the workflow process that interact with workflow services 402 through network 408.

According to one embodiment, a project management system operates in conjunction with a workflow engine to define and execute processes. The project management system allows optimal process definition from a resource-utilization and a scheduling perspective. The workflow engine provides the support for defining complex logical expressions that determine a path of execution for the defined tasks. In addition to composition capabilities, the workflow engine may execute and track the defined processes.

The workflow engine may execute workflow services 402, which includes composition 410, constraints 414, and tracking 416. Composition 410 may include workflow actions (e.g. action 412). Components of workflow services 402 are for illustrative purposes and other implementations may include additional or fewer components without departing from a scope and spirit of the invention.

Workflow system 400 is arranged to implement automated workflow via composable actions. In the example embodiment, a plurality of users 1-N access workflow services 402 via network 408. In practice, users 1-N may access workflow services 402 through client applications.

Workflow services 402 may operate independently of the user interfaces and other details of users 1-N. Thus, users 1-N may take a variety of forms or be uniform as desired. Workflow services 402 may perform workflow processing via a composition service such as composition 410. Composition 410 may assemble composable actions (e.g. action 412) into activity flows. Composable actions are workflow instances that may be arranged in a group such as an activity flow. Activity flows are executable sets of one or more composable actions.

Workflow services 402 may coordinate an activation, instantiation, or execution of flow between the actions in an activity flow. For example, assembly of various components of a product may be the composable actions grouped into the activity flow of fabricating the product itself. Composition 410 may send and receive messages to users 1-N or other systems according to standard interfaces.

Indications of the messages may be stored by a tracking service (e.g. tracking 416) for later retrieval. The tracking service may track a number of different aspects of the workflow such as tracking the status of activity flows. Constraints may be defined generically to support a wide variety of forms. For example, a constraint may evaluate various aspects of a current scenario and compare it to a store indicating which actions or targets are available for the current scenario. The available actions or targets may be provided to client software, which may present them for consideration by participants during execution or construction of an activity flow.

In addition to being applied before any action is executed, constraints may also be applied at execution time of associated activity flows. Although constraints may be used to limit what participants can do next, they may also have the corollary effect of guiding participants on what actions are available during execution of the workflow. In this way, the system may avoid overwhelming a user with numerous meaningless options, and a simple but effective user interface can be presented.

An exemplary constraint restricts which participants can perform which actions or initiate an activity flow based on a particular activity model. For example, access to a particular action or activity model can be restricted to a particular role, group, or participant. A constraint service such as constraints 414 may impose constraints generically with respect to facts and implement the constraints to impose a wide variety of controls to guide users during workflow processing. The constraint service may consult a fact store to apply constraints 414 as appropriate. The fact store may be a database or similar storage system. Such a fact store may contain a wide variety of information for an organization, and new fact types can be accommodated.

In other embodiments, workflow system 400 may have any number of client programs, execute over a plurality of networks, and support a wide variety of concurrently or simultaneously executing actions and activity flows.

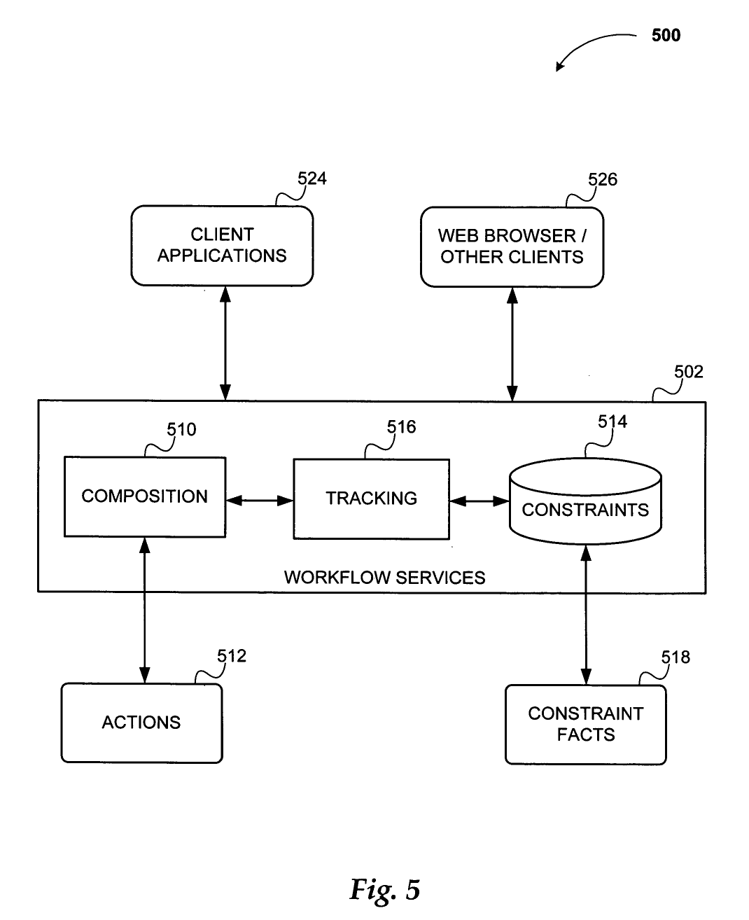

FIG. 5 shows diagram 500 illustrating example functional blocks of workflow system 400 of FIG. 4 and its interactions. Diagram 500 includes workflow services 592, actions 512, constraint facts 518, client applications 524, web browser and other clients 526. Similar to FIG. 4, workflow services 592 includes composition 510, tracking 516, and constraints 514.

In the example embodiment, client applications 524 may leverage workflow services 502 to enable actors to create and take part in workflow. Workflow services 502 may provide services to client applications 524 including, but not limited to, workflow composition 510, workflow constraints 514, and workflow tracking 516.

Workflows may be created by composing actions 512 within an activity flow. The composition of actions 512 is governed by constraints 514 that are enforced by workflow services 502. Constraints 514 may be defined in any number of known methods, including through a workflow administration and management system or through an administrative Application Programming Interface (API) in a programmatic manner. The present invention is not limited to a particular workflow system implementation with the project associated workflow aspects. Hence, a project-managed workflow may be executed by any capable workflow system according to one embodiment.

The definition of constraints 514 may leverage constraint facts 518 exposed by fact retrievers. Fact retrievers may implement a standard interface so that the constraint service can query these facts and apply them to the workflow. A fact retriever may expose constraint facts 518 from any underlying data source, such as an Active Directory or SQL database.

Client applications 524 may register with workflow services 502 when they desire to participate in an activity flow. Composition service 510 may associate a unique ID with the client request and use this ID to keep track of actions 512 that a user performs as part of the activity flow.

Tracking service 516 may be used to keep track of the state of the activity flow and to reconstruct the activity flow as requested by a client. When a client application makes an attempt to attach an action 512 to the activity flow, the constraint service may check constraints 514 (e.g., based on constraint facts 518 or the state of a flow) to see which actions 512 can be attached in the activity flow. For example, displayed options can be limited to those available under the constraints. After the user selects an action from the constrained set, the composition service can compose selected actions 512 with those already in use.

Actions 512 may be instrumented to emit tracking events that are consumed by the tracking service, tracking 516. These events may then be accessed by the client application to provide an up-to-date workflow to the user.

In one embodiment, workflow services 502 may further interact with web browser/other clients 526 to receive input or provide feedback based on the tracking service.

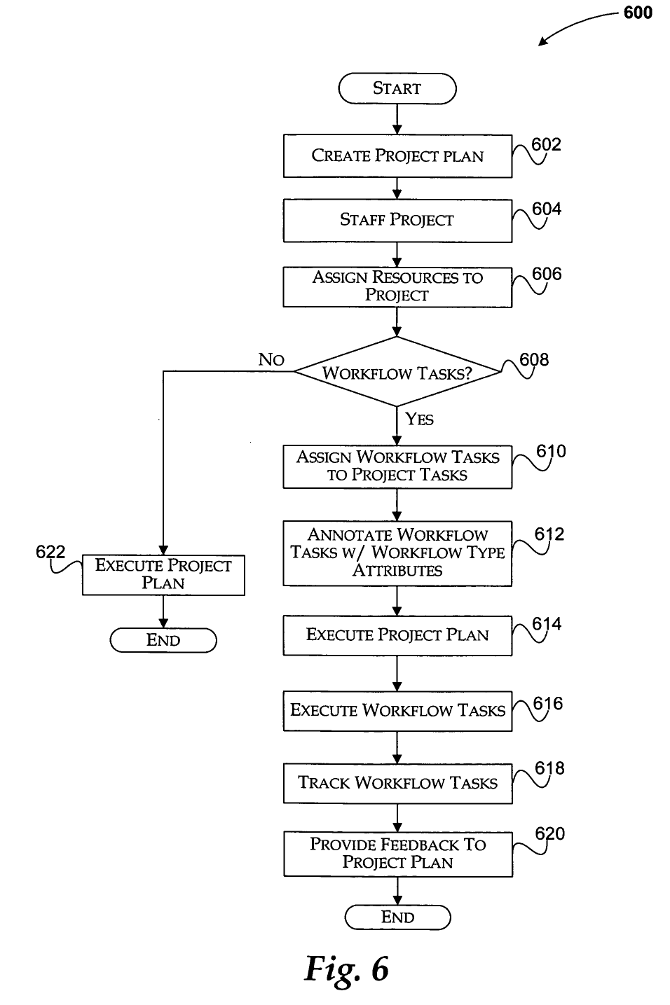

FIG. 6 is a logic flow diagram illustrating process 600 for project management in coordination with workflow management. Process 600 may be implemented in a project management application such as project management application 120 of FIG. 1.

Process 600 is an example embodiment for illustration purposes. The invention is not limited to the flowchart blocks or the order of blocks of process 600. Other embodiments of the present invention may be implemented in another process with fewer or additional blocks and in other orders without departing from the scope and spirit of the invention.

Process 600 starts at block 602, where a project plan is created. Processing then moves to block 604.

At block 604, the project is staffed. Staffing the project includes assigning staff responsible for particular task(s) (circle-dots), individual responsibilities for tasks, and the like. Next, processing advances to block 606.

At block 606, resources are assigned to the project. Some tasks within the project may be shared or overlapping. Similarly, each task may have one or more resources assigned to it. Tasks may have conditional association with other tasks and may have time and/or sequence based constraints defined. Some tasks may be recurring. Project managers may use a project management system to optimize project execution and resource utilization. For projects that are repetitive with the same tasks being repeated as part of each project instance, project managers may choose to automate the project using a workflow system. Processing moves from block 606 to decision block 608.

At decision block 608, a determination is made whether the project plan includes associated workflow tasks. If the project plan does not include associated workflow tasks, processing proceeds to block 622 where the project plan is executed. If the project plan includes associated workflow tasks, processing moves to block 610.

At block 610, workflow tasks are assigned based on project tasks. Some project tasks may be assigned due to their repetitive nature. Others may result in one or more workflow tasks. Processing proceeds to block 612 next.

At block 612, workflow tasks are annotated with workflow type attributes. Workflow type attributes define a behavior and implementation of workflow tasks in the workflow system. For example, a workflow task for “Analyze Inspection Results” may be annotated with “Analyze” annotation indicating the workflow task is under the analysis category, which may designate responsibility, reporting type, and the like associated with the workflow task category. Workflow tasks may be arranged by a workflow engine in activity flows. Processing advances from block 612 to block 614.

At block 614, tasks of the project plan are executed sequentially or simultaneously depending on the project plan. As the project plan is executed, associated workflow tasks may also be executed in coordination with the project plan at block 616. Processing advances to block 618.

At block 618, workflow tasks are tracked. The workflow system is arranged to track progress of workflow tasks as they are executed. Depending on the workflow type, tracking may include a number of metrics such as inspection results, production throughput, customer satisfaction, and the like. Processing moves next to block 620.

At block 620, the workflow system provides feedback to project management system based on the tracking results. The feedback may be provided for running and completed instances of workflows when project management system requests the data or on a scheduled basis where workflow data is transformed and saved as project plans. After block 620, processing moves to calling process for further actions. In one embodiment, none of the tasks of the project plan may require workflow tasks, but a compilation of workflow tasks may be started following the completion of the project plan.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for workflow instrumentation within a project, comprising:
providing a platform for constructing a project plan;
configuring the project plan to allow association with a workflow component, wherein a workflow component type is defined based on the project plan; and
providing an automated coordination between the workflow component and at least one portion of the project plan.

2. The method of claim 1, further comprising:
defining one or more project tasks associated with the project plan;
scheduling the one or more project tasks; and
assigning resources and staff to the one or more project tasks, wherein at least one project task is associated with a workflow component.

3. The method of claim 2, further comprising:
annotating at least one project task to provide the definition of the workflow component type; and
transferring the annotated project task to a workflow system such that associated workflow components are organized within the workflow system.

4. The method of claim 2, wherein each project task is generated as a document and the annotation is included in metadata of the document.

5. The method of claim 2, wherein the workflow component is at least one of a workflow task and a workflow instance.

6. The method of claim 2, wherein the project plan includes arbitrary levels of project tasks that are hierarchically related.

7. The method of claim 2, further comprising:
automatically modifying workflow components in a workflow system based on dynamic changes to the project plan.

8. The method of claim 7, further comprising:
tracking a progress of each workflow component; and
reporting a tracking result to the project plan.

9. The method of claim 8, wherein reporting the tracking result includes transmitting at least one of an analysis result, a metric, an alert, and a request to at least one of an application that executes the project plan, a web browser, and a message exchange application.

10. The method of claim 8, further comprising:
updating the project plan based on the tracking report; and
presenting the updated project plan employing a user-selectable view format when the tasks in the project are scheduled using a scheduling methodology for at least one of optimal resource, time utilization, and scope management.

11. A computer-readable medium having computer instructions for workflow instrumentation within a project, the instructions comprising:
providing a platform for constructing a project plan;
defining one or more project tasks associated with the project plan;
configuring the project plan to allow association between the project tasks and workflow components, wherein a workflow component type is defined based on the associated project task; and
providing an automated coordination between the workflow components and at least one portion of the project plan.

12. The computer-readable medium of claim 11, the instructions further comprising:
annotating at least one project task to provide the definition of the workflow component type; and
transferring the annotated project task to a workflow system such that the associated workflow components are organized within the workflow system.

13. The computer-readable medium of claim 12, the instructions further comprising:
tracking a progress of each workflow component within the workflow system; and
reporting a tracking result to a project management system executing the project plan.

14. A system for workflow instrumentation within a project, comprising:
a project management application that is arranged manage the project in coordination with workflow services and perform actions including:
providing a platform for constructing a project plan;
defining one or more project tasks associated with the project plan;
configuring the project plan to allow association between the project tasks and workflow services, wherein the workflow services include workflow components that are defined based on the associated project task; and
providing an automated coordination between the workflow services and at least one portion of the project plan;
at least one database that includes information associated with at least one workflow component and one project task; and
a user interface that is arranged to provide a user with an opportunity to interact with at least one of the project plan and the workflow services.

15. The system of claim 14, wherein the workflow services are provided by a workflow management application that is arranged to automatically modify the workflow components based on dynamic changes to the project plan.

16. The system of claim 15, wherein the workflow management application is further arranged to track a progress of each workflow component and report a tracking result to the project management application.

17. The system of claim 14, wherein the workflow components include action flows comprising at least one composable action and constraints that are based on facts from a fact database.

18. The system of claim 17, wherein the user's interaction includes at least one of:
modifying at least one of the composable actions and the constraints;
adding new facts to the facts database;
modifying at least one of scheduling and staffing properties of the project tasks; and
receiving at least one of a report, an alert, and a request.

19. The system of claim 15, wherein the workflow management application, the project management application, and the user interact over a network.

20. The system of claim 14, wherein the project management application is further arranged to:
update the project plan based on a workflow tracking report; and
present the updated project plan employing a user-selectable view format when the tasks in the project are scheduled using a scheduling methodology for at least one of optimal resource, time utilization, and scope management.
